(19) United States
(12) Patent Application Publication
(10) Pub. No.: US 2008/0055338 A1
(43) Pub. Date: Mar. 6, 2008

(54) MULTI-STAGE EDGE-DIRECTED IMAGE SCALING

(75) Inventors: Jeff Wei, Richmond Hill (CA); Marinko Karanovic, Markham (CA)

Correspondence Address: VEDDER PRICE KAUFMAN & KAMMHOLZ, 222 N. LASALLE STREET, CHICAGO, IL, 60601, US

(73) Assignee: ATI Technologies Inc., Markham (CA)

(21) Appl. No.: 11/468,686

(22) Filed: Aug. 30, 2006

(51) Int. Cl. G09G 5/00

(52) U.S. Cl. 345/667

(57) ABSTRACT

A multi-stage method of scaling an input image to form a scaled output image and an apparatus for doing the same, are disclosed. The method includes forming pixels of an intermediate image from the input image using edge-directed interpolation in the first stage. The intermediate image contains pixels of the input image, and interpolated pixels that are formed by interpolating pixels of the input image, using edge-directed interpolation. Output image pixels are computed in a second stage by determining an associated intermediate pixel coordinate of a corresponding pixel in the intermediate pixel coordinates for each output pixel. Output pixels are then computed by interpolating pixels of the intermediate image.

### FIELD OF THE INVENTION

The present invention relates generally to scaling of digital images, and more particularly to image scaling using edge-directed interpolation.

### BACKGROUND OF THE INVENTION

Digital images are used in a wide array of applications. These include motion video, still images, animation, video games, and other graphical applications that display images on display screens that may stand alone, or form part of other electronic devices, such as computers, handheld devices in the form of telephones, personal digital assistants, or the like.

One of the advantages of digitally storing image content is the ease of image processing that is afforded by the use of image processing implemented in hardware, software or both. Typical image processing activities include magnification or reduction of images, texture mapping, rotation, sharpening, smoothing, background removal, and color space conversion.

Among the most common image processing tasks is the scaling of images to reduce or increase the size of an input image. Display devices such as computer monitors, digital television sets and handheld device screens have a wide variety of display resolutions. Some have high resolutions which allow large, high-resolution pictures to be displayed without degrading the picture quality. Such display screens may also permit an up-scaled or magnified version of an input image to be displayed. Others have low-resolution displays may require the reduction in size, of the input image before the picture can be displayed. Many modern displays are capable of only displaying images of a fixed, pre-defined size.

Thus, various scaling algorithms are known. Conventional algorithms used in the magnification of digital images include nearest neighbor (also known as pixel replication), bilinear, bicubic and other polynomial interpolation methods. There are also nonlinear methods and transform based methods that are used to interpolate new intermediate pixels in magnified images.

Interpolation refers to the construction of unknown pixel values from known pixel values. When a picture of M×N pixels is say scaled by a factor of 2 horizontally and also by a factor 2 vertically (that is, its area is quadrupled), the new image has 2M×2N (or 4MN) pixels. There are thus at least 3MN more pixels in the new image, than in the input image. New pixel values must be determined. Interpolation is used to deduce an unknown pixel value from surrounding known pixels. In a simple nearest-neighbor interpolation, the nearest known sample is used as the value of the new pixel. In linear interpolation (such as bilinear interpolation, poly-phase filtering), the value of an interpolated pixel is calculated as a weighted sum of known pixels. In bilinear interpolation, typically the nearest input pixels surrounding the new pixel are used.

However, there are various disadvantages associated with conventional image scaling methods. For example, image scaling methods that make use of simple methods such as nearest-neighbor or bilinear interpolations are often of low quality, resulting in uneven jagged artifacts along diagonal lines (called jagged edges) in the output image. Other methods involve higher order interpolations and transforms that are computationally intensive and require several iterations.

There is accordingly a need for a high quality, relatively low complexity method of to scale images.

### SUMMARY OF THE INVENTION

Methods and an apparatus for image scaling using edge-directed interpolation are provided in embodiments of the present invention. A multi-stage image scaling procedure is used. Pixels of an intermediate image are formed from pixels of an input image using edge-directed interpolation. Pixels of the output image are formed from pixels of the intermediate image.

In accordance with one aspect of the present invention, there is provided a method of scaling an input image to form a scaled output image. The method includes forming selected pixels of an intermediate image which is formed by interpolating pixels of the input image using edge-directed interpolation. The intermediate image is made up of pixels at integer coordinates of an intermediate coordinate system. The method involves, for each pixel of the output image, determining a corresponding pixel coordinate in the intermediate coordinate system; and interpolating at least two of the selected pixels of the intermediate image using the corresponding pixel coordinate to form selected pixels of the output image.

In accordance with another aspect of the present invention, there is provided an image scaling device. The device includes an edge-interpolation block for forming selected pixels of an intermediate image which is formed by interpolating pixels of the input image using edge-directed interpolation. The intermediate image is made up of pixels at integer coordinates of an intermediate coordinate system. The device also includes a sampling-grid generator for determining a corresponding pixel coordinate in the intermediate coordinate system for each pixel of the output image. The device also includes an interpolation block for interpolating at least two of the selected pixels of the intermediate image, using the corresponding pixel coordinate to form selected pixels of the output image.

In accordance with yet another aspect of the present invention there is provided a method of scaling an input image to form a scaled output image. The method includes receiving an input image; generating pixels of an intermediate image from the input image, using edge-directed interpolation; and forming the scaled output image by interpolating the pixels of the intermediate image.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1 is a pixel representation of an image of size 4×4;

FIG. 2 is a pixel representation of a partial image corresponding to an up-scaled version of the image of FIG. 1;

FIG. 3A is a pixel representation of an up-scaled version of the image of FIG. 1, up-scaled using a first conventional scaling method;

FIG. 3B is a pixel representation of an up-scaled version of the image of FIG. 1, up-scaled using a second conventional scaling method;

FIG. 4 illustrates bilinear interpolation to calculate intermediate pixels to complete the image of FIG. 2;

FIG. 5 is a flow chart of a pixel interpolation method, exemplary of an embodiment of the present invention;

FIG. 6 is a flow chart of one block in the pixel interpolation method of FIG. 5, exemplary of an embodiment of the present invention;

FIG. 6B is a pixel representation of an image of size 3×3;

FIG. 6C is a pixel representation of an intermediate image buffer of size 5×5;

FIG. 6D is a pixel representation of an intermediate image buffer of size 5×5 partially filled with input pixels from the image of FIG. 6B;

FIG. 6E is a representation of the intermediate image buffer of FIG. 6D, completely filled with pixel values;

FIG. 7A is a flow chart of a local edge-directed interpolation block of FIG. 6, exemplary of an embodiment of the present invention;

FIG. 7B is a pixel representation of an intermediate image buffer partially filled with input pixels, illustrating the selection of a kernel-defining window surrounding a pixel to be interpolated;

FIG. 7C illustrates different possible orientations of interpolation for one type of new intermediate pixel in a 4×6 kernel, in an exemplary embodiment of the present invention;

FIG. 7D illustrates different possible orientations of interpolation for a second type of new intermediate pixel in a 4×6 kernel, in an exemplary embodiment of the present invention;

FIG. 7E illustrates different possible orientations of interpolation for a third type of new intermediate pixel in a 4×6 kernel, in an exemplary embodiment of the present invention;

FIG. 7F illustrates one exemplary extrapolation of a pixel outside of a 4×6 kernel, in an exemplary embodiment of the present invention, when the kernel size is too small;

FIG. 8 is a flow chart of the determination of a local edge orientation of FIG. 7A in an exemplary of an embodiment of the present invention;

FIG. 9A is a flow chart of a block in the pixel interpolation method of FIG. 5 exemplary of an embodiment of the present invention;

FIG. 9B is a representation of output pixels of an output image, using co-ordinates of the intermediate image;

FIGS. 9C-9D show an exemplary determination of barycentric coordinates for a pixel P using vertices A, B and C of a triangle ABC in FIG. 9B;

FIGS. 10A-10B show an exemplary triangular interpolation of the value of a pixel P using its barycentric coordinates over a triangle ABC; and

FIG. 11 illustrates an exemplary hardware that implements the interpolation method, in an exemplary embodiment of the present invention.

### DETAILED DESCRIPTION

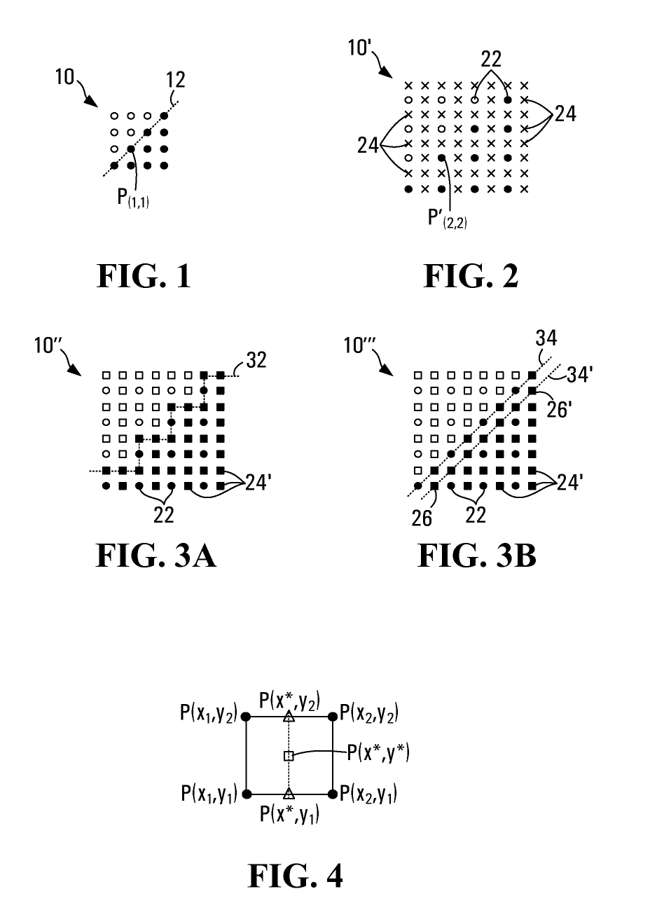

FIG. 1 is a 4×4 grid of pixels representing an input image 10. A local edge 12 may be observed dividing darker and lighter regions in image 10. For simplicity, a gray-scale image is considered so that each pixel may be represented by one scalar value. However, the discussion that follows applies to color images whose pixel values would be represented as vectors or tuples comprised of multiple scalar color values. Most operations that are carried out on gray-scale images can be similarly performed on color images on a per color basis. In FIG. 1, a pixel at coordinate (x, y) is denoted P(x, y).

FIG. 2 illustrates a representation of a partial image 10′ that is an up-scaled version of image 10 depicted in FIG. 1, up-scaled in a conventional manner. Image 10′ is an 8×8 grid of pixels, and includes input pixels 22 corresponding to the pixels of image 10 (FIG. 1). The remaining pixels of partial image 10′ have unknown values, and are deduced to form a complete image. Input pixels 22 of FIG. 2 are shown at their new respective positions in the up-scaled image 10′. Thus, for a magnification by a factor of two, both horizontally and vertically, the input pixel at coordinate (1,1) in FIG. 1 is mapped to coordinate (2, 2) in FIG. 2. In other words the value of pixel P′(2,2) in FIG. 2 is the same as P(1,1) in FIG. 1.

Remaining pixels 24 of FIG. 2 may be calculated using conventional interpolation methods such as nearest-neighbor, bilinear interpolation, bi-cubic interpolation, transform based methods, finite impulse response (FIR) filters or the like.

FIGS. 3A and 3B each show a compete image 10″ and 10′″ respectively, formed from the partial image of FIG. 2, with the remaining unknown pixels interpolated using two different methods. The input pixels are denoted as either clear or shaded circles. Interpolated pixels are shown as squares. Image 10″ is formed using nearest-neighbor interpolation is depicted in FIG. 3A. In nearest neighbor interpolation, each interpolated pixel takes the value of its “nearest neighbor” input pixel. A diagonal edge 32 defined by the black (dark) and white (light) regions in FIG. 3A is therefore a jagged line, which is caused by aliasing and is visually displeasing to the eye.

In contrast, FIG. 3B depicts an image 10′″ formed using edge-directed interpolation. An edge-directed interpolation method takes the existence of a local edge 12 (FIG. 1) into account. Thus in FIG. 3B edge-directed interpolations proximate edge 34 are carried out along lines parallel to, or approximately parallel to edge 34. For interpolation along a line with no input pixels, such as line 34′, or at a distance away from edge 34′, pixels such as pixels 26, 26′ may be interpolated horizontally or vertically, or in other directions not influenced by the orientation of edge 12. Using edge-directed interpolation, an up-scaled image 10′″ should display a smooth diagonal edge 34 as defined by the darker and lighter pixel regions of FIG. 3B.

Another conventional method called bilinear interpolation is illustrated with reference to FIG. 4 which depicts an enlarged view of an arbitrary section in FIG. 2 containing four input pixels. Using bilinear interpolation, the pixel value at a coordinate (x*,y*) can be linearly interpolated. Four input samples identified by their new Cartesian coordinates as P(x₁,y₁), P(x₂, y₁), P(x₁,y₂) and P(x₂,y₂) are used for interpolation. Since the size of scaled image is simply double that of image 10 of FIG. 1, (x*,y*) correspond to coordinates x*=½ (x₁+x₂) and y*=½(y₁+y₂).

In general, input pixels nearest to (x*,y*) are typically chosen for interpolation to yield best results although any four pixels at positions (x₁,y₁), (x₂, Y₁), (x₁,y₂) and (x₂,y₂) which satisfy the inequalities x₁≦x*≦x₂ and y₁≦y*≦y₂ may be used.

First the pixel values P(x*,y₂), and P(x*,y₁) are interpolated. P(x*, y₂) is horizontally interpolated from the known values P(x₁, y₂) and P(x₁, y₁). Thus, defining

$$α = \frac{{x}_{2} - {x}^{*}}{{x}_{2} - {x}_{1}}$$

(α=½ in FIG. 2) horizontal interpolations can proceed as:

P(x*,y₂)=αP(x₁,y₂)+(1−α)P(x₂,y₂) (1a)

P(x*,y₁)=αP(x₁,y₁)+(1−α)P(x₂,y₁) (1 b)

Similarly, defining

$$β = \frac{{y}_{2} - {y}^{*}}{{y}_{2} - {y}_{1}} ,$$

P(x*,y*) is then calculated as:

P(x*,y*)=βP(x*,y₁)+(1−β)P(x*,y₂) (1C)

As mentioned, for the case of doubling an image as shown in FIG. 2,

$$α = \frac{1}{2} and β = \frac{1}{2} .$$

Although bilinear interpolation may lead to better results than nearest neighbor methods, jagged edges can still be observed in diagonal lines in linearly interpolated up-scaled images.

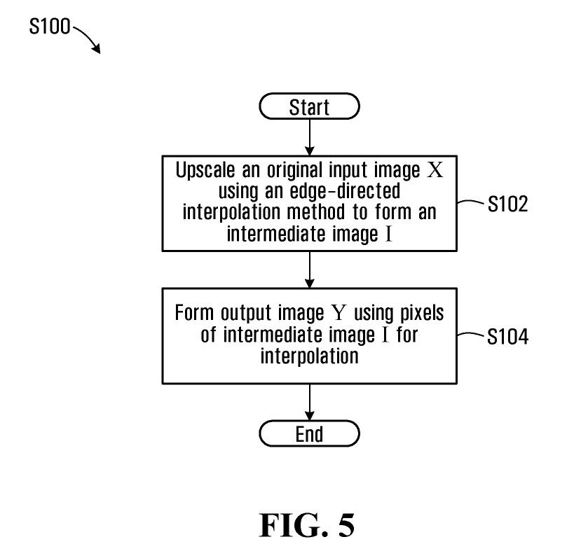

Up-scaling and interpolation methods exemplary of embodiments of the present invention, reduce jagged edges and produce more visually appealing, smooth diagonal edges. As such, an exemplary method involves at least two interpolation stages and is generally summarized with the aid of blocks S100 shown in FIG. 5. Blocks S100 may be implemented in hardware, software or both. As illustrated in block S102, pixels of image I, which is an up-scaled version of an input image X, are calculated. In block S104, pixels formed in block S102 are interpolated to form pixels of a final output image Y. Upscaling in block S102 uses a local edge-directed (or edge oriented) interpolation method which helps reduce artifacts, such as jaggies and the like. Interpolation in block S104 may be a more computationally efficient, such as linear interpolation.

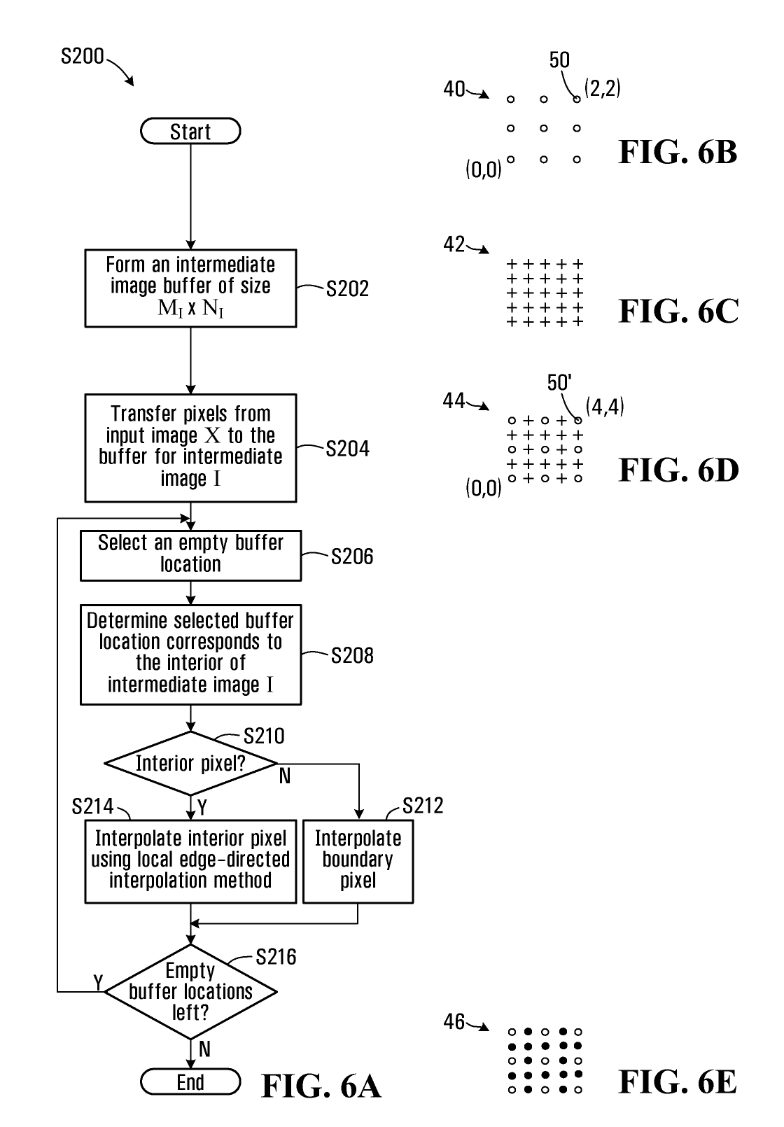

Steps involved in the formation of intermediate image I in block S102 of FIG. 5 are further illustrated in blocks S200 of FIG. 6. The size of intermediate image I is predetermined. For reasons that will become apparent, an intermediate image size about double the size of the input image X in each direction is a good choice. Thus, assuming the size of input image X is Mₓ×Nₓ, then the size of the corresponding intermediate image, M_{I}×N_{I} may be chosen so that M_{I}=(2Mₓ−1) and N_{I}=(2Nₓ−1). Accordingly an intermediate image buffer, i.e., two dimensional array of pixels in memory, of size M_{I}×N_{I} is allocated in block S202.

FIG. 6B illustrates an example input image 40 which is 3×3 in size (that is Mₓ=3 and Nₓ=3) to be scaled using blocks S200. After block S202, the intermediate image buffer, which is initially empty as shown in FIG. 6C, is formed. In intermediate image buffer 42, plus signs (+) denote un-interpolated pixels (empty buffer locations).

As mentioned, if the number of columns in the input image is Mₓ, the number of columns M_{I} in the corresponding intermediate image is chosen as 2Mₓ−1. Similarly, if the number of rows in the input image is Nₓ, the number of rows N_{I} in the corresponding intermediate image is chosen as 2Nₓ−1. In block S204, pixels from input image X are mapped to their respective coordinates in the intermediate image I to form image 44. Intermediate pixel I(2i,2j) is set to the value of input pixel X(i,j) where 0≦i<Nₓ and 0≦j<M^{x}. The value of pixel 50 of FIG. 6B at coordinate X(2,2) in the input image X is thus mapped to pixel 50′ of FIG. 6C in intermediate image position I(4,4). As expected, since a scaling factor of 2 is used, intermediate image buffer locations corresponding to odd rows or odd columns will be empty. That is, odd column or odd row image buffer locations, that is I(2i,2j+1), I(2i+1,2j) or I(2i+1,2j+1), represent new intermediate pixels that should be formed.

As will be appreciated, different intermediate image sizes (other than images that are horizontally and vertically scaled by a factor of about 2) may be used. Similarly, other mappings of pixels in the input image to the intermediate image will be apparent to one of ordinary skill.

In one exemplary embodiment, the interpolation in intermediate image buffer 44 may proceed by first selecting an empty buffer location to fill, in block S206. As will become apparent, a sub-image of the intermediate image, containing a two dimensional array of input pixels, of a predetermined size, may be formed around a pixel that is to be formed using edge-directed interpolation. The window may thus be considered a sub-image of the input image. A pixel in the intermediate image that has enough mapped input pixels (i.e., pixels mapped from the input image in block S204) around it to form a window or sub-image of predetermined size may be classified as an interior pixel. As can be appreciated, pixels at or near the top row or left most column, right most column and bottom row may not allow a window to be formed around them. Depending on the window size, pixels proximate the boundary of the image, such as those on the second left most or second rightmost column may also not allow a window of mapped input pixels to be formed around them. Such pixel coordinates that are near the boundary, and do not allow a window of mapped input pixels, of a predetermined size, to be formed around them may be classified as boundary pixels.

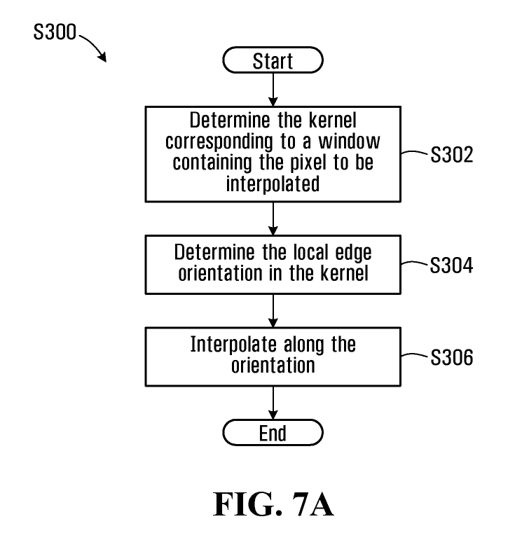

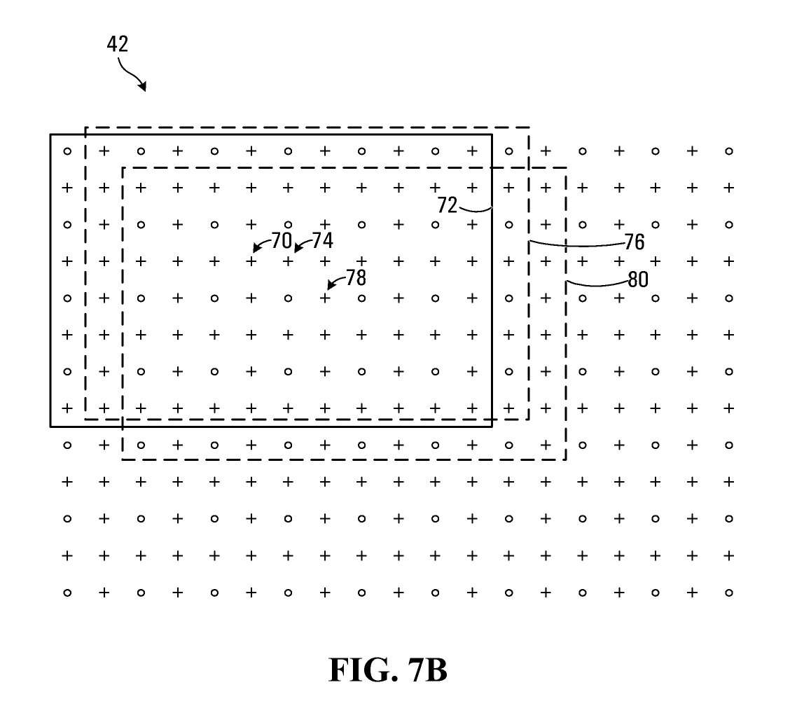

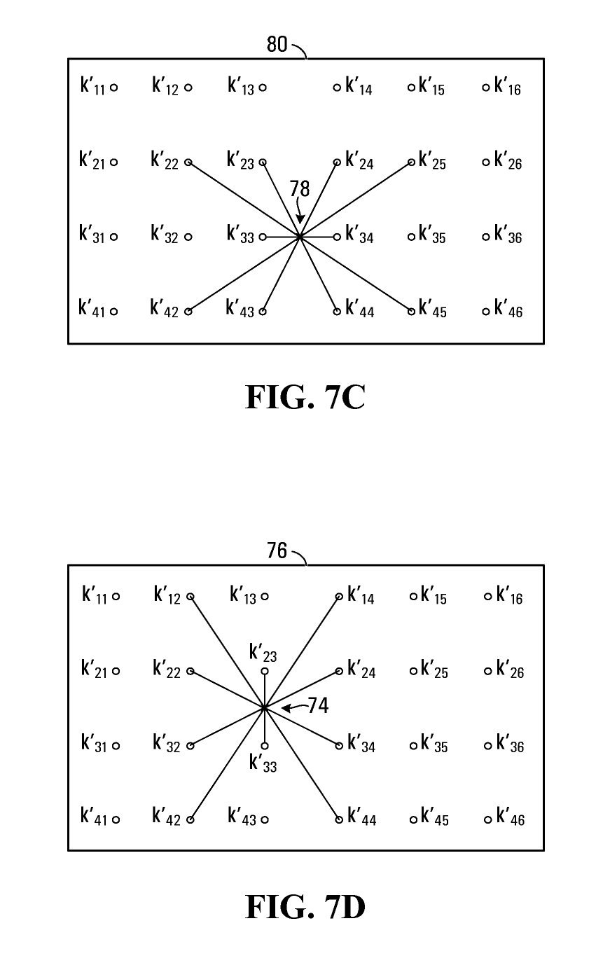

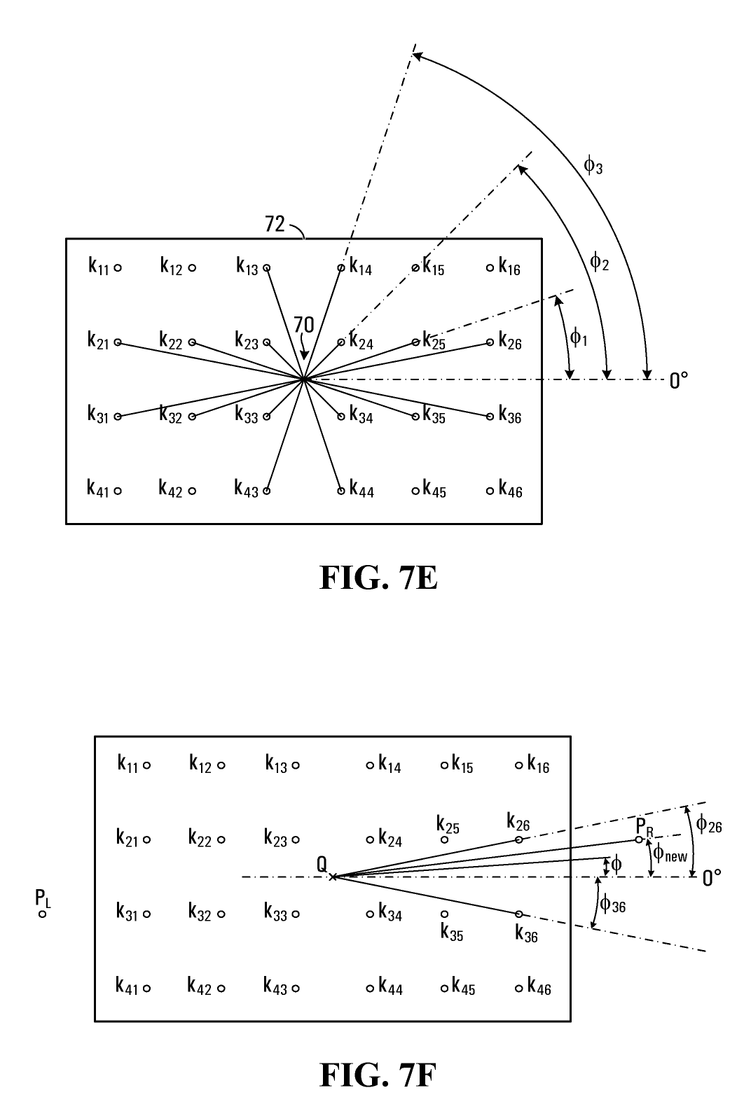

Specifically, a window size of 8×12 may be used in an exemplary embodiment. As depicted in FIG. 7B, given a window of size 8×12, for a pixel to be formed at empty buffer location I(x,y), a corresponding window may be formed (e.g. window 72 for pixel 70). It can be seen from FIG. 7B that, for a pixel at I(x, y), the bottom-left pixel of its corresponding window is at I(x−5, y−4), the top-left pixel of the window is at I(x−5, y+3), the bottom-right pixel of the window is at I(x+6, y−4) and the top-right pixel of the window is at I(x+6, y+3).

For such a window size, pixels at I(x,y) for which the conditions 0≦x−5<N_{I}, and 0≦x+6<N_{I}, and 0≦y+3<M_{I}, and 0≦y−4<M_{I} are interior pixels. Conversely, pixels for which these four conditions are not satisfied may be classified as boundary pixels. Thus, in block S208, an empty buffer location I(x,y) (representing a pixel to be formed by interpolation) is classified as an interior pixel or a boundary pixel as noted just above.

In block S210, if the selected buffer location is for an interior pixel, then in block S214, the pixel value is formed from mapped input pixels 50′ using a local edge-directed interpolation. On the other hand, if the selected buffer location is for a boundary pixel, its value may be determined using conventional interpolation methods such as bilinear interpolation, either horizontally or vertically in block S212. Of course, the majority of pixels in typical applications will be interior pixels. If more empty image buffer locations exist (S216) that need to be determined, then the process may be repeated for the next empty buffer location at block S206. Blocks 200 may be implemented in software. Software containing processor executable instructions, executing on a computing machine with a processor and memory, may be used to carryout blocks 200. Alternately hardware embodiments may be used. As will become apparent, intermediate image I, need not be fully constructed as described. Accordingly, in hardware embodiments, only a few intermediate pixels near an output pixel location may be interpolated.

Local edge-directed interpolation in block S214 is further illustrated using blocks S300 of FIG. 7. The position of the pixel to be determined is known and already identified as an interior pixel (from S210 of FIG. 6). In block S302, a window corresponding to the pixel position is selected. As mentioned, the window is a sub-image of the intermediate image containing the pixel to be formed, and the surrounding pixels including mapped input pixels. A kernel, corresponding to window 72 of FIG. 7B, is a two dimensional matrix of mapped input pixels inside window 72. In the exemplary embodiment shown in FIG. 7B, window 72 is formed around pixel 70, whose value is to be determined. The kernel corresponding to window 72, is a two dimensional matrix made up of the twenty-four input pixels enclosed in window 70 (FIG. 7B). For pixel 74 immediately to the right of pixel 70, the corresponding window 76 may be formed by shifting window 72 to the right by one pixel position. As may now be apparent, for pixel 78 situated one pixel position below and one pixel position to the right of pixel 74, a corresponding window 80 may be formed by shifting window 74′ to the right by one pixel position, and below by one pixel position.

In the depicted embodiment, each window corresponding to a pixel to be formed is unique. In addition, windows corresponding to adjacent pixel positions to be formed are of fixed size and thus overlap. However, in alternate embodiments, the intermediate image may be subdivided into disjoint sub-images or windows, and an interpolated pixel may be formed using the particular sub-image to which it belongs. Thus the sub-image used to interpolate a pixel may not be unique to that pixel. In other embodiments, the sizes of different sub-images may also be different. Many other variations on how sub-images are formed for interpolation will be apparent to those of ordinary skill.

A 4×6 kernel K corresponding to a window (e.g. window 72) is shown as a kernel matrix below.

$$K = [ \begin{matrix}{k}_{11} & {k}_{12} & {k}_{13} & {k}_{14} & {k}_{15} & {k}_{16} \\ {k}_{21} & {k}_{22} & {k}_{23} & {k}_{24} & {k}_{25} & {k}_{26} \\ {k}_{31} & {k}_{32} & {k}_{33} & {k}_{34} & {k}_{35} & {k}_{36} \\ {k}_{41} & {k}_{42} & {k}_{43} & {k}_{44} & {k}_{45} & {k}_{46}\end{matrix} ]$$

Now, each intermediate pixel to be formed (or empty image buffer location) in FIG. 7B may be classified as one of three types in accordance with FIGS. 7C-7E. As shown, each pixel to be formed may be determined by interpolating along one of a number of possible directions. Interpolation may take place along any one of the lines shown in FIGS. 7C-7E.

Pixel 78 (FIG. 7C) is a ‘type 1’ pixel to be formed. Pixel 78 lies along a row containing input pixels. For a ‘type 1’ pixel, the nearest input pixels are the input pixel immediately to the left and the input pixel immediately to the right of the new intermediate pixel along a horizontal line.

Pixel 74 (FIG. 7D) is a ‘type 2’ pixel to be formed. Pixel 74 lies along a column containing input pixels. For a ‘type 2’ pixel, the nearest input pixels are the input pixel immediately above and the input pixel immediately below the new intermediate pixel along a vertical line.

Pixel 70 (FIG. 7E) is a ‘type 3’ pixel to be formed. Pixel 70 lies along a column and a row containing no input pixels. Thus for a ‘type 3’ new intermediate pixel, the nearest input pixels are along diagonal lines intersecting at the new intermediate pixel position.

Once the kernel is determined in block S302, its local edge-orientation is determined in block S304. The local edge-orientation for pixel 70 may be one of the lines shown in FIG. 7E. At the end of block S304, one of the lines in FIG. 7E, representative of the local edge-orientation for the kernel, may be selected. After the local edge direction selected, pixel 70 may be formed by interpolating along the selected line in block S306. The interpolation may be linear interpolation of the two mapped input pixels at the endpoints of the selected line.

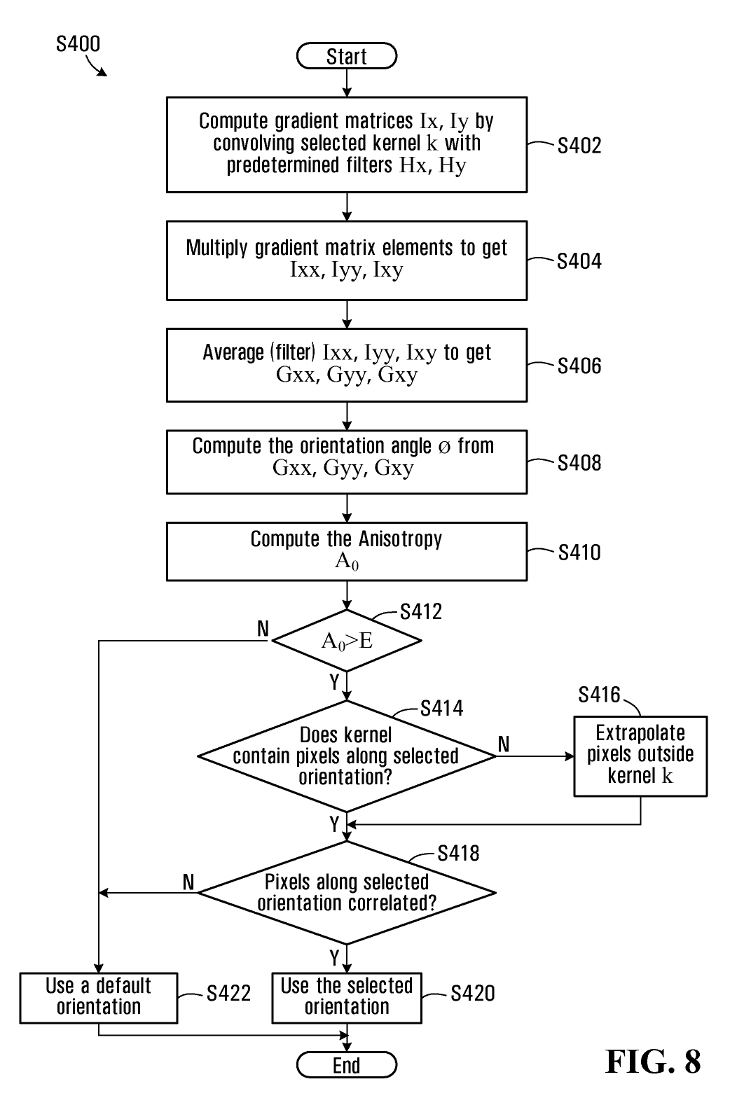

The local edge-orientation is determined using kernel K in blocks S400 depicted in FIG. 8. The determination of local edge-orientation involves finding the gradients along the horizontal and vertical directions, processing associated gradient matrices, low-pass filtering, and calculating the orientation angle. Several qualification criteria are subsequently imposed to determine the orientation to use, as detailed below.

The method starts with a pixel to be formed 70 (or its corresponding empty image buffer location) and its associated kernel K of suitable size comprising input pixels.

In block S402 the gradients of the kernel are computed. To determine the gradients, a pair of filters Hx, Hy are used to spatially filter (convolve with) kernel K. As shown below exemplary filters Hx and Hy are 2×2 matrices.

$$Hx = [ \begin{matrix}+ 1 & + 1 \\ - 1 & - 1\end{matrix} ] Hy = [ \begin{matrix}+ 1 & - 1 \\ + 1 & - 1\end{matrix} ]$$

The convolution yields two matrices Ix and Iy corresponding to Hx and Hy respectively. In other words,

Ix=K*Hx

Iy=K*Hy

where * denotes the convolution operator.

During the convolution of K and Hx, the elements kᵢⱼ of kernel K are multiplied with the elements of filter Hx and summed to produce the elements Ixᵢⱼ of Ix. Digital convolutions of this type are well known in the art.

Specifically, the top left element Ix₁₁ of Ix is computed using elements of Hx and K as

Ix₁₁=Hx₁₁k₁₁+Hx₂₁k₂₁+Hx₁₂k₁₂+Hx₂₂k₂₂=k₁₁−k₂₁+k₁₂−k₂₂. The second element Ix₁₂ on the top row is similarly computed after first shifting the gradient matrix Hx to the right by one column so that the elements of Hx are superimposed with k₁₁, k₁₂, k₂₁ and k₂₂. The calculation of Ix₁₂ thus proceeds as Ix₁₂=Hx₁₁k₁₂+Hx₂₁k₂₂+Hx₁₂k₁₃+Hx₂₂k₃₃=k₁₂−k₂₂+k₁₃−k₃₃ and so on. After the first row of Ix is computed, Hx is shifted down and to the left, so that its elements align with k₂₁, k₂₂, k₃₁ and k₃₂ and the process continues for the second row.

The computation of Iy proceeds in an identical manner but using Hy instead. The convolution is carried out without zero padding K at the edges. Therefore the resulting sizes of Ix and Iy are 3×5 for a kernel size of 4×6.

In block S404, matrix products of the gradient matrices are computed. Three matrix products Ixx, Iyy and Ixy are computed. Given matrix Ix with elements Ixᵢⱼ (where 1≦i≦3 and 1≦j≦5), elements Ixxᵢⱼ (1≦i≦3 and 1≦j≦5) of Ixx are computed as Ixxᵢⱼ=(Ixᵢⱼ)². Similarly given matrix Iy with elements Iyᵢⱼ (1≦i≦3 and 1≦j≦5), the elements Iyyᵢⱼ (1≦i≦3 and 1≦j≦5) of matrix Iyy are computed as Iyyᵢⱼ=(Iyᵢⱼ)². Finally matrix Ixy with elements Ixyᵢⱼ (1≦i≦3, 1≦j≦5) is computed by multiplying corresponding elements Ix and Iy so that the elements of the resulting matrix Ixy are computed as Ixyᵢⱼ=(Ixᵢⱼ)(Iyᵢⱼ). Each of the calculated matrices Ixx, Iyy, Ixy is a 3×5 matrix.

Matrices Ixx, Iyy and Ixy, which are all 3×5, are then low-pass filtered in block S406 using a low-pass filter H_{LP} (a 3×5 matrix with all its elements set to 1 as shown below).

$${H}_{LP} = [ \begin{matrix}1 & 1 & 1 & 1 & 1 \\ 1 & 1 & 1 & 1 & 1 \\ 1 & 1 & 1 & 1 & 1\end{matrix} ]$$

An arbitrary smoothing filter may be used as H_{LP}. Any matrix with all elements being positive valued can serve as a suitable low-pass filter. Using the depicted low-pass filter H_{LP}, filtering simply sums together all elements of the input matrix (i.e., Ixx, Iyy or Ixy).

The filtering operations yield three scalar values Gₓₓ, G_{yy} and G_{xy} which represent the sums or averages of the squared gradients Ixxᵢⱼ, Iyyᵢⱼ, Ixyᵢⱼ in matrices Ixx, Iyy and Ixy respectively. One skilled in the art would appreciate that the values Gₓₓ, G_{yy} and G_{xy} are elements of the averaged gradient square tensor G̅ represented by a symmetric 2×2 matrix shown below.

$$\overline{G} = [ \begin{matrix}{G}_{xx} & {G}_{xy} \\ {G}_{xy} & {G}_{yy}\end{matrix} ]$$

The gradient square tensor, (also known as the approximate Hessian matrix or the real part of the boundary square matrix) uses squared (quadratic) gradient terms which do not cancel when averaged. It is thus possible to average or sum gradients of opposite direction which have the same orientation, so that the gradients reinforce each other rather than canceling out. Gradient square tensors are discussed in for example, Lucas J. van Vliet and Piet W. Verbeek, “Estimators for Orientation and Anisotropy in Digitized Images”, Proceedings of the First Annual Conference of the Advanced School for Computing and Imaging, Heijen, Netherlands, May 16-18, pp. 442-450, 1995 and also in Bakker, P., Van Vliet L. J., Verbeek, P. W., “Edge preserving orientation adaptive filtering”, IEEE Computer Society Conference on Computer Vision and Pattern Recognition. Vol. 1 pp. 540, 1999, the contents of which are both hereby incorporated by reference.

In block S408, the angle of orientation φ is determined. Specifically, smoothed gradient square tensor G̅ preserves the average gradient angle information and thus allows calculation of the orientation angle. The angle of orientation φ can be calculated from the elements of smoothed gradient square tensor G̅. Specifically, eigenvalues λ₁ and λ₂ are calculated by solving the determinant in the equation | G̅−λI|=0 where I is the identity matrix. Eigen values λ₁ and λ₂ can be expressed using intermediate values P, Q, R, as

λ₁=½(P+R) (2a)

λ₂=½(P−R) (2b)

where P and R as related as

P=Gₓₓ+G_{yy} (2c)

Q=Gₓₓ−G_{yy} (2d)

R=\sqrt{Q²+4(G_{xy})²} (2e).

The orientation angle φ is then computed from the largest eigenvalue λ₁ as

$$ϕ = {tan}^{- 1} ( \frac{{λ}_{1} - {G}_{xx}}{{G}_{xy}} ) \qquad ( 2 f )$$

Orientation angle φ evaluates to a value between −90° and 90°. The direction (or line) closest to the calculated value of φ may be taken as the orientation. For example, in FIG. 7E, the line from k32 to k25 corresponds to an angle value Φ₁=arctan(⅓)≈18.430, while the line from k33 to k24 corresponds to an angle Φ₂=arctan( 1/1)=45°. Thus, if φ=50°, the line from k33 to k24 (i.e., Φ₂=45°) may be used. However if φ=10° the line from k32 to k25 (i.e., Φ₁≈18.43°) may be used. Accordingly, all possible values of φ may be divided into ranges that map to a specific line (direction) of interpolation that includes two mapped input pixels. As will be appreciated, implementing equations (2a) to (2f) directly in hardware may be difficult. Accordingly, in hardware embodiments, simplified forms of the equations and approximations that are more amenable to hardware implementation may be used.

In block S410, orientation angle φ is further qualified by anisotropy calculation. The anisotropy A₀ is preferably defined as

$${A}_{0} = \frac{{P}^{2}}{{G}_{xx} {G}_{yy} - {G}_{xy} {G}_{xy}} = \frac{{( {G}_{xx} + {G}_{yy} )}^{2}}{{G}_{xx} {G}_{yy} - {G}_{xy} {G}_{xy}} \qquad ( 3 )$$

The anisotropy A₀ is intended to give a measure of the energy in the orientation relative to the energy perpendicular to the orientation, but need not be defined necessarily as set out in equation (3). For example, the absolute value of a Sobel operator may be used.

For computed angles that are, or close to, integral multiples of 90° (0°, 90° 180°, 270°), the anisotropy tends to be larger than for other orientations. This is because anisotropy varies nonlinearly with the angle. Different threshold values corresponding to different ranges of angles may thus be used to qualify interpolation orientations. For example, a threshold of about 6 may be used for angles in the range of about 30° to 60°. A threshold of about 24 may be used for angles near 14° and a threshold value of about 96 may be used for angles that are less than about 11°.

In the exemplary embodiment, a kernel of size 4×6 is used. The size is somewhat arbitrary and may of course be increased. It should be appreciated that increasing the kernel size (by increasing the associated window size in the intermediate image) would also increase computational complexity. On the other hand, if the size of the kernel is too small, then the number of lines available for interpolation may be too small. That is, the computed angle φ may be wider (or narrower) than the widest (or narrowest) angle available inside the window. In this case, pixels outside of the window may be extrapolated and used. For example, Φ₂₆ (FIG. 7F) may not be suitable, and thus a new pixel P_{R} may be used to form a new angle Φ_{new}. Extrapolated pixel P_{R} preferably lies along a line (direction) which forms angle Φ_{new} that is closer to φ than any of the angles Φᵢ of existing lines formed within the kernel.

An example of such an extrapolation (block S416) is shown in FIG. 7F. To extrapolate sample point P_{R}, it is first noted that P_{R} is two columns to the right of k₂₆. Thus P_{R} is extrapolated by adding twice the gradient (k₂₆−k₂₅) to k₂₆.

P_{R}≈k₂₆+2(k₂₆−k₂₅)=3k₂₆−2k₂₅ (4a)

Similarly extrapolation function for P_{L} is given as

P_{L}≈k₃₁+2(k₃₁−k₃₂)=3k₃₁−2k₃₂ (4b)

As can be appreciated by an ordinary person skilled in the art, better approximation is achieved by extrapolation when extrapolated points P_{R}, P_{L} are closer to the kernel.

A further qualification criterion may be imposed for the candidate orientation, in block S418. The orientation may be qualified using pixel correlation. To calculate pixel correlation, the absolute difference between two pixels that lie along lines that include the new intermediate pixel is computed (FIG. 6C). If the computed absolute difference between pixels along the selected orientation is the smallest (or very close to the smallest difference), then the orientation is qualified.

At the conclusion of blocks S400, the orientation to use in forming a new intermediate pixel 70 (FIG. 7B) should be known. The calculated value of orientation angle φ, once qualified in blocks S410, S412, S418, is used to select a line (orientation) among those shown in FIGS. 7C-7E. The line forming an angle closest to orientation angle φ is selected.

If a candidate orientation is not suitable (S412, S418), then in block S422 a default orientation may be selected, which may be horizontal for a ‘type 1’ pixel, vertical for a ‘type 2’ pixel and a predetermined diagonals for a ‘type 3’ pixel.

Returning to FIG. 7, in block S306 interpolation proceeds along the selected line or orientation. New intermediate pixel 70 (FIG. 7B) may be formed by linearly interpolating (calculated as the average of the pixels) along the qualified orientation angle. If, for example, the selected orientation is along the line from k₁₄ to k₄₃ (in FIG. 7E), the value of new intermediate pixel 70 is determined by linearly interpolating along the diagonal line from the values of pixels k₁₄, k₄₃. If k₁₄, k₄₃ are equidistant from intermediate pixel 70 as in this example, the interpolated value is simply the average of the two pixel values.

As shown in FIG. 6, in one embodiment, the interpolation process is repeated until all empty buffer locations of the intermediate image (FIG. 6B) are filled (S216), resulting in a completed intermediate image 46 in FIG. 6E. However, in alternate embodiments, required intermediate pixels may be computed as needed. That is, for a given output pixel location, only the intermediate pixels required to calculate the output pixel may be determined without determining all intermediate pixels in intermediate image I. As will become apparent, this helps avoid large buffers for hosting entire intermediate images, and may be better suited for hardware implementations.

Referring back to FIG. 5, the formation of a complete intermediate image concludes block S102. The next block S104, involves the interpolation of output image Y using pixels of the intermediate image formed in block S102.

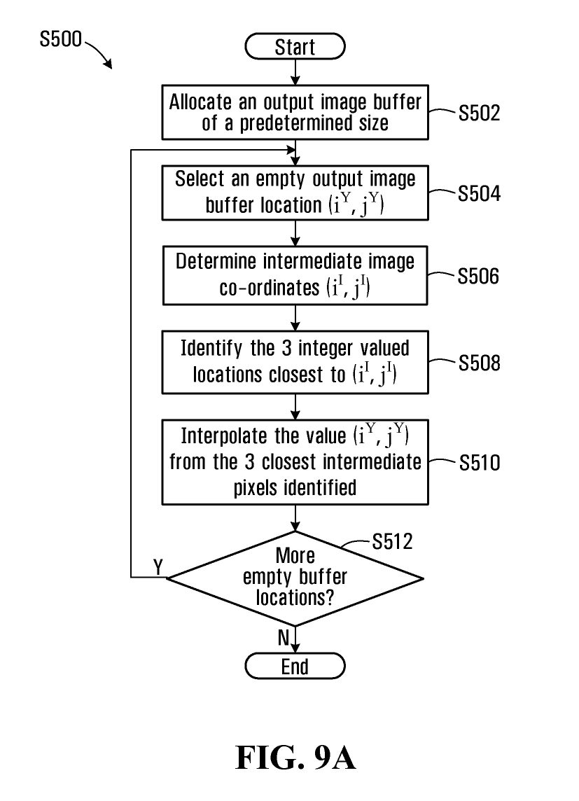

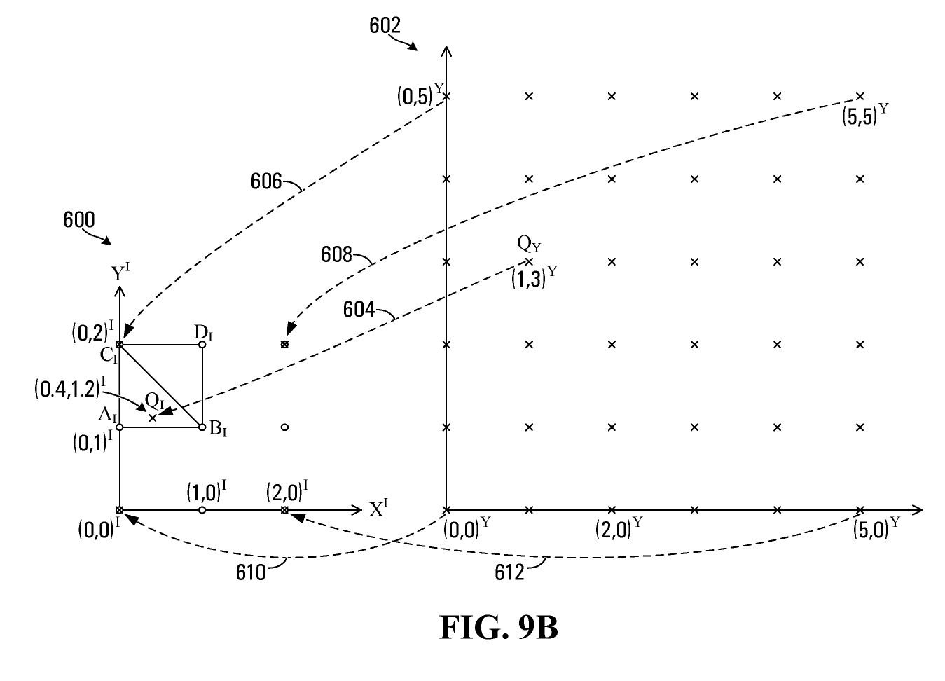

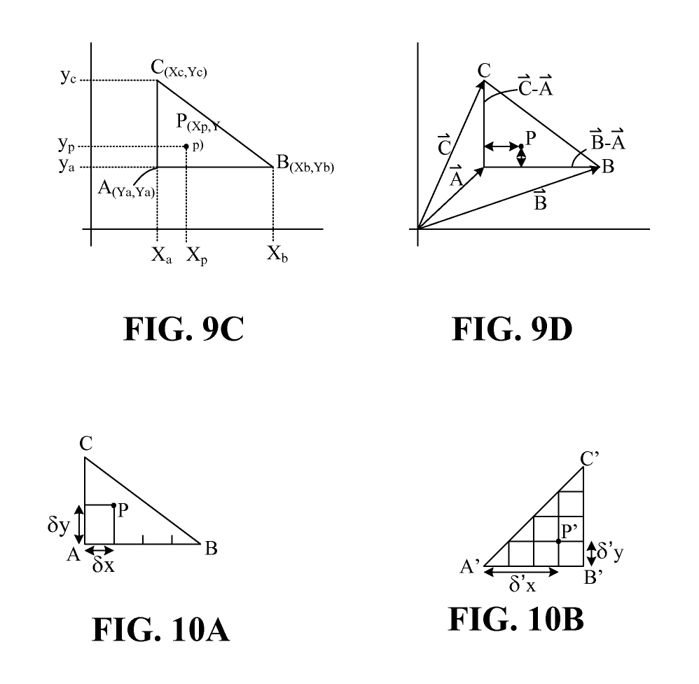

Blocks S500 of FIG. 9 illustrates blocks involved forming an output image Y from pixels of the intermediate image I. Software executing on a computing device, exemplary of an embodiment of the present invention, may start by allocating an output image buffer of predetermined size (M_{Y}×N_{Y}) in block S502.

In block S504, an empty output image buffer location Y(x,y) corresponding to an output pixel, is selected for interpolation.

A pixel Q at Y(x,y) in the output image buffer, may be written as a point in a two dimensional output coordinate system at coordinate (x^{Y}, y^{Y}). As depicted in FIG. 9B, pixel Q at image buffer Y(x,y) may be written as a point Q_{y} at coordinate (x_{Q}, y_{Q})=(1,3) in an output coordinate system 602. Hereinafter the position of Q_{y} is denoted (x_{Q}, y_{Q})^{Y} or (x_{Q}^{Y}, y_{Q}^{Y}) to indicate that the coordinate is in the output coordinate system. Thus Q_{y} is located at (1,3)^{Y}.

Similarly, any pixel B at I(x,y) in the intermediate image, may be represented as a point at an integer coordinate (x_{B}, y_{B}) of an intermediate coordinate system. Hereinafter, the coordinate of a point such as B in the intermediate coordinate system is denoted B_{I}, at (x_{B}, y_{B})^{I} or (x_{B}^{I}, y_{B}^{I}) to indicate that the coordinate is in intermediate coordinate system 600. Thus B, is located at (1,1)^{I}.

Thus, the intermediate pixel in the intermediate image buffer location I(0,0), is shown at coordinate (0,0)^{I} in intermediate coordinate system 600. Similarly intermediate pixel I(0, 2) in the intermediate image buffer, is shown at coordinate (0, 2)^{I} in intermediate coordinate system 600.

In order to determine the value of an arbitrary pixel Q_{y} in the output image, from the intermediate image, a corresponding coordinate of a pixel Q_{I} in image I is determined. Once the corresponding coordinate is known, the value of pixel Q_{I} may be determined from values of known intermediate pixels, proximate Q_{I}. The determined value of pixel Q_{I} may then be used as the value of Q_{Y}.

In other words, for each output pixel Q denoted by a point Q_{y} at (x_{Q}, y_{Q})^{Y} in the output coordinate system 602, coordinates of an associated point Q_{I} at intermediate pixel coordinates (x_{Q},y_{Q})^{I} in the intermediate coordinate system 600 may be determined. After determining the associated intermediate pixel coordinates in the intermediate coordinate system 600, intermediate pixels in image I proximate or close to Q_{I} can be identified and used for interpolation.

For each pixel of the output image having a pixel value at its associated intermediate pixel coordinate in the intermediate image, the pixel value from the intermediate image may be mapped directly to the output pixel Q of the output image. For other pixels of the output image, at least two selected pixels of the intermediate image may be combined to form the output pixel Q of the output image.

A number of associations 604, 606, 608, 610, 612 from output coordinate system 602, to intermediate coordinate system 600 are depicted in FIG. 9B. Intermediate coordinate system 600 contains intermediate image pixels denoted by circles (∘). Coordinates associated with output pixel positions are denoted by (x). Those output image pixels mapped to a coordinate of an existing intermediate image pixel are shown as (\textcircled{×}). For example, both pixel I(0,0) of the intermediate image and Y(0,0) of the output image map to coordinate (0,0)^{I}, which is shown as (\textcircled{×}) in intermediate coordinate system 600. Similarly, associations 606, 608, 610 and 612 of output pixel positions from output coordinate system 602, to positions in the intermediate coordinate system 600, are already occupied by intermediate pixel positions.

Output pixel Y(0,5) is associated with coordinate (0, 2)^{I} in intermediate coordinate system 600 by association 606. Similarly output pixel Y(1,3) is mapped to coordinate (0.4, 1.2)^{I} by association 604. This mapping of an output pixel Q_{y} at (x_{Q}, y_{Q})^{Y} or (x_{Q}^{Y}, y_{Q}^{Y}) in the output coordinate system into its corresponding pixel in the intermediate coordinate system, Q_{I} at (x_{Q}^{I}, y_{Q}^{I}) is accomplished in block S506. Typically however, input pixels do not map to integer coordinates of the output coordinate system.

Notably, the associated intermediate coordinates (x_{Q}^{I}, y_{Q}^{I}) in intermediate coordinate system 600, of an output pixel Q, may have non-integer co-ordinate values. That is, x_{Q}^{I} or y_{Q}^{I} may not be integers. For example, the coordinate of output pixel Q_{y} which is (x_{Q}^{Y}, y_{Q}^{Y})=(1, 3)^{Y} is mapped to coordinate (x_{Q}^{I}, y_{Q}^{I})=(0.4, 1.2)^{I} by mapping 604. However, the intermediate image is specified by pixels at integer coordinates of the intermediate coordinate system. Thus intermediate pixels at integer coordinates, that can be used to interpolate output pixel Q, are identified in block S508.

To determine the associated coordinate (x_{Q}, y_{Q})^{I} in intermediate coordinate system 600 of output pixel Q (at output coordinate system (x_{Q}^{Y}, y_{Q}^{Y})=(1,3)), the values x_{Q}^{Y} and y_{Q}^{Y} may be multiplied by a horizontal and vertical co-ordinate transformation factors fₓ and f_{y} respectively to compute x_{Q}^{I} and y_{Q}^{I}. fₓ, f_{y} reflect the horizontal and vertical scaling of the input image to form the scale output image Y. Since output pixel at output coordinates (5,0)^{Y} maps to intermediate coordinates (2,0)^{I}, a horizontal coordinate transformation factor may easily determined as fₓ=⅖. Similarly since output coordinate (0,5)^{Y} maps to intermediate coordinate (0,2)^{I}, a vertical coordinate transformation factor of f_{y}=⅖ should be used.

In general, a coordinate transformation factor fₓ in the horizontal dimension, may be determined from the number of intermediate columns M_{I} and the number of output columns M_{y} in that dimension, as

fₓ=(M_{I}−1)/(M_{y}−1).

Similarly, a coordinate transformation factor f_{y} in the horizontal dimension, may be determined from the number of intermediate rows N_{I} and the number of output columns M_{y} in that dimension, as

f_{y}=(N_{I}−1)/(N_{y}−1).

Thus pixel Q at output image coordinate Y(1,3), maps to (⅖, 6/5)^{I}=(0.4,1.2)^{I} after multiplying each by the appropriate coordinate transformation factor of ⅖. That is, in association 604, intermediate coordinates (x_{Q},y_{Q})^{I} for pixel Q are calculated from the coordinate of Q_{y}, which is (1,3)^{Y} as

x_{Q}^{I}=(fₓ)(x_{Q}^{Y})=⅖×1.0=0.4

y_{Q}^{I}=(f_{y})(y_{Q}^{Y})=⅖×3.0=1.2

Now, from the calculated position (x_{Q}^{I}, y_{Q}^{I})=(0.4, 1.2)^{I,} software exemplary of an embodiment of the present invention can easily find the square of known intermediate pixels A_{I}B_{I}C_{I}D_{I} (FIG. 9B) at integer intermediate pixel coordinates that enclose pixel position (0.4,1.2)^{I}. Further, since 0.4 is closer to 0 than 1, and 1.2 is closer to 1 than 2 in the vertical direction, triangle A_{I}B_{I}C_{I} in FIG. 9B may easily be identified as the triangle enclosing (0.4, 1.2)^{I}, by the exemplary software.

The interpolation may now proceed with triangle A_{I}B_{I}C_{I}. A_{I}, B_{I} and C_{I} are located at to intermediate coordinates (0,1)^{I}, (1,1)^{I} and (0,2)^{I} respectively. Thus, in block S508 pixel values A_{I}=(0,1)^{I}, B_{I}=(1,1)^{I} and C_{I}=(0,2)^{I} from the intermediate image buffer locations I(0,1), I(1,1) and I(0,2), are identified as the pixels to use for interpolation.

In S510, an intermediate pixel value Q_{I} is formed from the intermediate pixel values identified in S508, (A_{I}, B_{I} and C_{I} corresponding to intermediate image buffer locations I(0,1), I(1,1) and I(0,2)). Once the intermediate pixel value Q_{I} is formed, the corresponding output buffer coordinate (that is Q_{Y}(1,3)) is populated with the newly determined output pixel value.

If empty output image buffer locations are left (S510) the process repeats at block S504 as shown. At the end of S500, a completely constructed output image should result.

In the depicted embodiment, triangular interpolation is used to interpolate pixel Q_{I} at non-integer coordinates. Of course, other suitable interpolation techniques could be used. Triangular interpolation, used in an exemplary of an embodiment of the present invention, is illustrated below. Triangle A_{I}B_{I}C_{I} of FIG. 9B is further depicted in FIGS. 9C-9D as triangle ABC using simplified notation. It is well known in algebraic geometry that two-dimensional points inside a triangle can be expressed using barycentric coordinates. That is, a point inside a triangle may be expressed as a linear combination or weighted sum of the three vertices of the triangle. As shown in FIG. 9C, given triangle ABC defined by vertices A at coordinate (x_{A},y_{A})^{I}, B at coordinate (x_{B},y_{B})^{I}, and C at coordinate (x_{C},y_{C})^{I}, the coordinate (x_{Q},y_{Q})^{I} of any point Q inside triangle ABC may be written as

(x_{Q},y_{Q})^{I}=r(x_{A},y_{A})^{I}+s(x_{B},y_{B})^{I}+t(x_{C},y_{C})^{I} where r+s+t=1 (5a)

Such a coordinate system is called a barycentric coordinate system. Since r+s+t=1, in equation (5a) r can be defined as 1−s−t and thus only s and t need to be calculated. Of course, a person skilled in the art may appreciate that there are many ways to determine the barycentric coordinates of a point in a triangle.

One way of determining barycentric coordinates is illustrated with a simple example shown in FIG. 9D. As noted, pixel Q_{I} to be formed, is located at coordinate (x_{Q},y_{Q})^{I} in the intermediate coordinate system. To express Q_{I} as a combination of pixels A_{I}, B_{I} and C_{I}, as in equation (5a), it is convenient to interpret each point as a vector. Thus the vector \vec{Q} in FIG. 9D defined by the origin of the coordinate system (0,0) as its starting point and the point P as its end point, can be expressed as

\vec{Q}=\vec{A}+s(\vec{B}−\vec{A})+t(\vec{C}−\vec{A}) (5b)

where t is the perpendicular distance of Q from line A̅B̅ (or vector \vec{B}−\vec{A}) normalized so that C is at a distance of 1.0. Similarly s is the perpendicular distance of pixel Q from line A̅C̅, normalized so that pixel B is at 1.0 from line A̅C̅.

Equation (5b) can then be simplified to yield

\vec{Q}=(1−s−t)\vec{A}+s\vec{B}+t\vec{C} (5c).

The coefficients (r, s, t) where r=1−s−t are known as the barycentric coordinates of Q over triangle ABC.

Given some known quantities A, B, and C at coordinates (x_{A},y_{A})^{I}, (x_{B},y_{B})^{I}, (x_{C},y_{C})^{I} respectively, an unknown quantity Q corresponding to coordinate (x_{Q},y_{Q})^{I} may be formed by interpolation from the barycentric coordinate values s and t using the formula

Q=(1−s−t)A+sB+tC (5d).

The unknown value Q may represent intensity, color, texture or some other quantity that is to be determined. In other words, given coordinate (x_{Q},y_{Q}), defining a line in three dimensions, the value Q is determined from the intersection of the line with the plane defined by the three, three-dimensional points (x_{A}, y_{A}, A), (x_{B}, y_{B}, B) and (x_{C},y_{C},C). In the present example the quantity of interest is pixel value which may be gray scale or alternately a red, green or blue color component.

FIG. 10A depicts triangle ABC of FIG. 9D. Using equation (5d), the values r, s, and t are readily determined as s=δx, t=δy and r=(1−δx δy). For Q, corresponding to output pixel coordinate in intermediate coordinate system (0.4, 1.2)^{I} in FIG. 9B, substituting δx=0.4 and δy=(1.2−1)=0.2 yields s=0.4, t=0.2 and r=1−s−t=0.4. Thus output pixel Q_{I} is simply computed by combining values of pixels A, B and C as Q_{I}=0.4A+0.4B+0.2C.

As another example, FIG. 10B illustrates another selected triangle A′B′C′ for containing another pixel P′ to be formed. The desired barycentric coordinates (r, s, t) can be calculated as described earlier but the equations (5c) cannot be used since the chosen triangle is different from triangle ABC used earlier. Thus, a new set of equations is derived as follows. We start by constructing the equation for vector \vec{P}′ corresponding to pixel P′ as \vec{P}′=\vec{A}′+δx′(\vec{B}′−\vec{A}′)+δy′(\vec{C}′−\vec{B}′) and further simplify the equation to get \vec{P}′=(1−δx′)\vec{A}′+(δx′−δy′)\vec{B}′+δy′(\vec{C}′) which is in the form of equation (5c). Thus the barycentric coefficients are readily available as r=1−δx′; s=δx′−δy′ and t=δy′ in terms of δx′ and δy′ shown in FIG. 9C. Recall that δx′ and δy′ are normalized so that 0≦δx′≦1 and 0≦δy′≦1.

The values of pixel A′, B′and C′are known. Hence, as δx′=¾ and δy′=¼ it follows that s=δx′−δy′=½; t=δy′=¼ and r=1−s−t=¼; Therefore the interpolated value P′=¼A′+½B′+¼C′ in accordance with equation (5d).

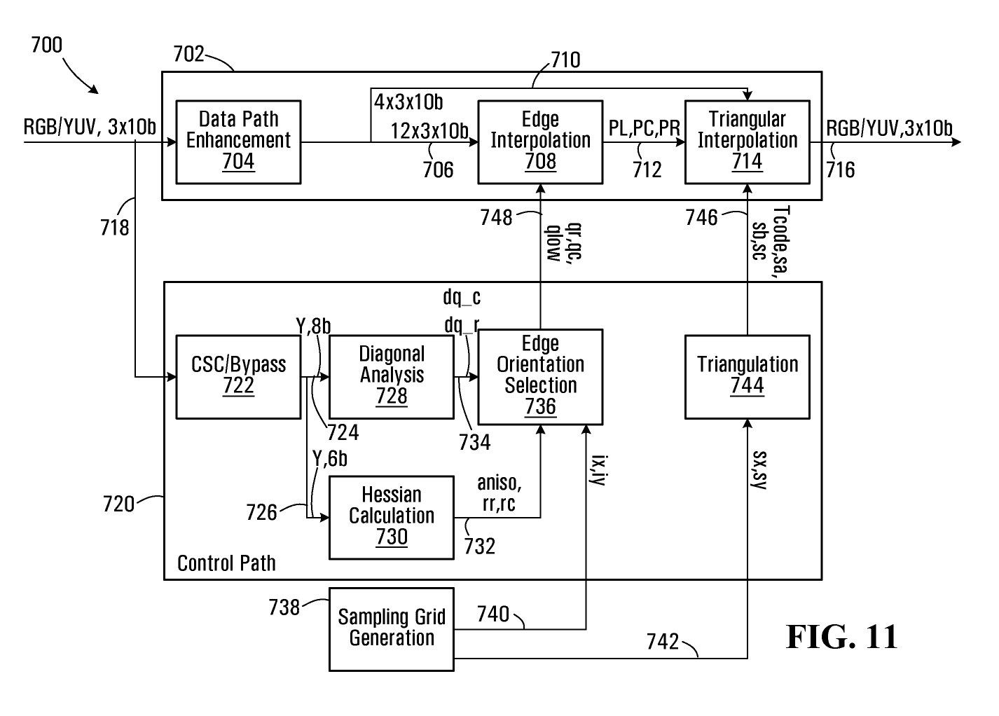

Exemplary embodiments may be realized in hardware or software. A schematic block diagram of an exemplary hardware device 700, exemplary of an embodiment of the present invention, is depicted in FIG. 11. Hardware device 700 has a data path 702 and a control path 720 and a sampling-grid generator 738. Data path 702 may include an optional enhancement block 704, edge-interpolation block 708, and interpolation block 714. Control path 720 involves a color-space-conversion (CSC) block 722, diagonal analysis block 728, Hessian matrix calculator 730, an orientation selector 736, and triangulation block 744.

Data interfaces 706, 710 interconnect enhancement block 704 with edge interpolator 708 and triangular interpolator 714 respectively. Interfaces 724, 726 interconnect color-space-conversion (CSC) block 722, diagonal analysis block 728 and Hessian calculator 730 respectively. Edge-orientation selector 736 receives input from diagonal analysis block 728 by way of interface 734, from Hessian calculator 730 by way of interface 732 and sampling-grid generator 738 by way of interface 740, and forwards its output to edge interpolator 708 by way of interface 748.

Triangulation block 744 receives its input from sampling-grid generator 738 and outputs vertex data via interface 746 to be transferred to interpolation block 714. Triangulation block 744 also receives the output of edge-interpolation block 708 through interface 712.

Pixels in RGB or YUV format are fed into the data path 702 and control path 720. CSC block 722 converts RGB values to YUV format and transmits the luma Y to diagonal analysis block 728 and Hessian calculator 730. CSC block 722 may be bypassed if the input is already in YUV format. The luma component (Y) is typically better suited for determination of edges and other line features. In addition, computational complexity may be reduced by limiting calculations to just one component, instead of three.

To interpolate intermediate pixels, Hessian calculation block 730 and diagonal analysis block 728 analyze a kernel made up of input pixels at their respective inputs 726, 724, and compute the orientation angle (blocks S402 to S410), anisotropy (block S410) and other qualification parameters. Hessian calculation block 730 and diagonal analysis block 728 thus perform blocks S400 depicted in FIG. 8. The outputs of Hessian calculator 730, and diagonal analysis block 728 are fed to edge-orientation selector 736.

Sampling-grid generator 740 generates the coordinates of an intermediate pixel to be formed in accordance with S300 of FIG. 7A, and provides the coordinates to edge-orientation selector 736 using interface 740. Edge-orientation selector 736, selects the edge orientation corresponding to the coordinate input using outputs of diagonal analysis block 728 and Hessian calculation block 730 (S304). Edge-orientation selector 736 then forwards the selected orientation information to edge-interpolation block 708. Edge-interpolation block 708 then interpolates the intermediate pixel along the selected direction (block S306).

In operation, the intermediate pixel values may be calculated as needed on per output pixel basis. Unlike in some software embodiments described above, no intermediate buffer may be required in the exemplary hardware embodiment depicted in FIG. 11, as only required pixels of intermediate image I are formed.

For example, in one specific hardware embodiment, a coordinate of an output pixel in the output coordinate system, may be used to generate its corresponding coordinate in the intermediate coordinate system by sampling-grid generator 738. The output coordinate may be divided by the horizontal and vertical scaling factors as noted above to determine the corresponding intermediate coordinate. The intermediate coordinate may then be used to easily identify a square defined by four mapped input pixels in the intermediate image, enclosing the output image coordinate by sampling-grid generator 738.

The coordinates of three interpolated pixels PL, PC, PR (FIG. 11) in the intermediate coordinate system may, for example, be the midpoint of the left vertical border of the square of mapped input pixels, the geometric center of the square, and the midpoint of the right border of the square, respectively.

The values of the three intermediate pixels may then be formed by interpolating within the square using edge-orientation selector 736 and edge-interpolation block 708. Edge-orientation selector 736 through its output interface 748 may provide the orientation information to edge-interpolation block 708. Edge-interpolation block 708 may then determine each of interpolated pixels PL, PC, PR, by interpolating along the selected orientation.

The coordinates of the interpolated pixels in the intermediate coordinate system may also be used to partition the square into six triangles by triangulation block 744. A triangle enclosing the output pixel coordinate in the intermediate coordinate system is subsequently used by interpolation block 714 to interpolate the output pixel value. Using vertex pixel values of the selected triangle fed from edge-interpolation block 708, and the barycentric coordinates fed from triangulation block 744, interpolation block 714 interpolates the output pixel, effectively carrying out block S510 in FIG. 9A, and outputs the value using its output interface 716.

Depending on their relative proximity to, coordinates of output pixels in the intermediate coordinate system, some intermediate pixels may never need to be formed, as they may not be needed to compute the output pixels.

Embodiments of the present invention are advantageous as they combine a two-stage process to interpolate pixels at arbitrary resolutions. In the first interpolation stage, intermediate pixels between input image pixels are formed by interpolating pixels of the input image, to form an intermediate image. In a second stage, triangular interpolation is used to determine output pixel values at arbitrary coordinates in the intermediate image. The new intermediate pixels formed by the first interpolation stage may be relatively sparse, which permits the use of high quality nonlinear interpolation methods without too much computational cost. The preferred first stage interpolation is an edge-directed interpolation method that reduces the appearance of jagged edges.

The output pixels are then computed during the second interpolation stage using triangular interpolation which is well known and computationally efficient.

Advantageously, embodiments of the present invention may be used for common input image sizes such as 720×486, 720×576, 720×240, 720×288, 704×480, 704×240, 1280×720, 1920×1080, 1920×1088, 1920×540, 1920×544, 1440×1080, 1440×540 and the like. Similarly, as many different scaling ratios including non-integer ratios may be accommodated, common output sizes such as 1920×1080, 1280×1024, 1024×768, 1280×768, 1440×1050, 1920×1200, 1680×1050, 2048×1200, 1280×720 and the like can be achieved using embodiments of the present invention.

In alternate embodiments, instead of using the edge-directed interpolation described with reference to FIGS. 7A-7F and FIG. 8, edge directional line averaging (ELA) may be used to interpolate intermediate pixels. ELA has modest computational costs and thus may be attractive in environments with limited computational resources. As the size of the intermediate image is typically double the size of the input image, interpolations may be carried out using simple averaging. In one embodiment, the absolute difference of pixels along each line of interpolation (in FIGS. 7C-7E) is computed. The line with the smallest difference of pixel values represents the highest correlation, and thus may be used for interpolation. Such schemes are more fully disclosed for example, in Ho Young Lee, Jin Woo Park, Tae Min Bae, Sang Um Choi and Yeong Ho Ha, “Adaptive Scan Rate Up-Conversion System Based on Human Visual Characteristics”, IEEE Transactions on Consumer Electronics, Vol. 46, No. 4, November 2004, the contents of which are hereby incorporated by reference.

In other alternate embodiments, bilinear interpolation may be used instead of triangular interpolation. For example, the square A_{I}B_{I}C_{I}D_{I} (FIG. 9B) may be divided into four smaller squares or sub-squares instead of triangles. The sub-square into which an output pixel coordinate in the intermediate coordinate system falls may be used to interpolate the output pixel value. Using the bilinear interpolation method as described above, the output pixel value may be determined by interpolating the vertices of the sub-square.

Other interpolation methods such as bi-cubic interpolation or nonlinear interpolation methods may also be used to improve the quality of interpolation usually at some computational cost.

In other alternate embodiments, multiple stages of the edge-directed interpolation step may be utilized. As may be appreciated, the intermediate image size may double with each stage of edge-directed interpolation. Accordingly, after n stages of edge-directed interpolation, the size of the intermediate image may be 2ⁿ times the size of the input image. Embodiments with multiple stages of the edge-directed interpolation step may be particularly suited for applications in which a large up-scaling ratio is required.

As will be appreciated, image scaling hardware device 700 may form part of electronic devices such as television sets, computers, wireless handhelds and displays including computer monitors, projectors, printers, video game terminals and the like.

Of course, the above described embodiments, are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

What is claimed is:

1. A method of scaling an input image to form a scaled output image, comprising:
forming selected pixels of an intermediate image which is formed by interpolating pixels of said input image using edge-directed interpolation, said intermediate image comprised of pixels at integer coordinates of an intermediate coordinate system;
for each pixel of the output image, determining a corresponding pixel coordinate in said intermediate coordinate system;
interpolating at least two of said selected pixels of said intermediate image, using said corresponding pixel coordinate to form selected pixels of said output image.

2. The method of claim 1, wherein said at least two of said selected pixels of said intermediate image comprise three of said selected pixels of said intermediate image enclosing said corresponding pixel coordinate, and wherein said interpolating comprises weighting said three of said selected pixels in dependence on the barycentric co-ordinates of said corresponding pixel coordinate relative to the coordinates of said three of said selected pixels in said intermediate coordinate system, to form selected pixels of said output image.

3. The method of claim 1, wherein said intermediate image has a size that is vertically approximately twice as large as said input image, and horizontally approximately twice as large as said input image.

4. The method of claim 1, wherein said intermediate image further comprises mapped pixels of said input image, and said forming said selected pixels of an intermediate image comprises,
forming a sub-image of said intermediate image comprising said mapped pixels of said input image, and
using said edge-directed interpolation in said sub-image to interpolate said mapped pixels of said input image.

5. The method of claim 4, wherein said edge-directed interpolation in said sub-image comprises,
forming a matrix K of predetermined size, comprising pixels of said input image in the sub-image;
computing an orientation angle φ for said matrix K; and
forming an interpolated pixel in said intermediate image by interpolating said pixels of said input image in the sub-image, along a direction corresponding to said orientation angle.

6. The method of claim 5, wherein said computing said orientation angle comprises:
forming a horizontal gradient matrix Ix and a vertical gradient matrix Iy corresponding to said matrix K;
squaring each element of said gradient matrix Ix to form Ixx;
squaring each element of said gradient matrix Iy to form Iyy;
multiplying together corresponding elements of said gradient matrices Ix and Iy to form Ixy;
averaging Ixx, Iyy and Ixy to form elements Gₓₓ, G_{yy} and G_{xy} and forming a gradient square matrix
$$\overline{G} = [ \begin{matrix}{G}_{xx} & {G}_{xy} \\ {G}_{xy} & {G}_{yy}\end{matrix} ] ;$$
solving for the largest eigenvalue λ₁ of said gradient square matrix; and
solving for said orientation angle
$$ϕ = {tan}^{- 1} ( \frac{{λ}_{1} - {G}_{xx}}{{G}_{xy}} ) .$$

7. The method of claim 6, wherein said gradient matrices are formed by convolving said matrix K with gradient filters Hx and Hy respectively, said gradient filters being
$$Hx = [ \begin{matrix}+ 1 & + 1 \\ - 1 & - 1\end{matrix} ] and Hy = [ \begin{matrix}+ 1 & - 1 \\ + 1 & - 1\end{matrix} ]$$

8. The method of claim 6, wherein said edge-directed interpolation further comprises extrapolating pixels for use in said edge-directed interpolation having positions that lie outside of said sub-image, from pixels inside said sub-image in said direction corresponding to said orientation angle.

9. The method of claim 1, wherein said input image has a size of about one of 720×486, 720×576, 720×240, 720×288, 704×480, 704×240,1280×720, 1920×1080, 1920×1088, 1920×540, 1920×544, 1440×1080 and 1440×540 pixels; and said output image has a size of about one of 1920×1080, 1280×1024, 1024×768, 1280×768, 1440×1050, 1920×1200, 1680×1050, 2048×1200 and 1280×720 pixels.

10. The method of claim 1, wherein said edge-directed interpolation is non-linear.

11. The method of claim 5, further comprising calculating an anisotropy value for said matrix K; and interpolating an interpolated pixel in said intermediate image using said pixels of said input image in said sub-image along said direction corresponding to said orientation angle, upon said anisotropy value exceeding a threshold.

12. The method of claim 11 wherein said threshold is about 6 for angles in the range of about 30° to 60°; about 24 for angles near 14°; and about 96 for angles less than 11°.

13. The method of claim 12 wherein said anisotropy value is determined according to the formula
$${A}_{0} = \frac{{( {G}_{xx} + {G}_{yy} )}^{2}}{{G}_{xx} {G}_{yy} - {G}_{xy} {G}_{xy}} .$$

14. The method of claim 5 further comprising checking for pixel correlation along said orientation angle; and forming said interpolated pixel in said intermediate image by interpolating said pixels of said input image in the sub-image along a direction corresponding to said orientation angle, upon a finding of pixel correlation along said orientation angle.

15. The method of claim 14, wherein said finding of pixel correlation comprises determining that the absolute difference between pixels along said direction corresponding to said orientation angle is the smallest among all possible directions

16. The method of claim 14, wherein said finding of pixel correlation comprises determining that the absolute difference between pixels along said direction corresponding to said orientation angle is within a predetermined threshold from the smallest absolute difference between pixels along all possible directions.

17. Computer readable medium, storing processor executable instructions that when loaded at a computing device, adapts said computing device to perform the method of claim 1.

18. An image scaling device comprising:
an edge-interpolation block for forming selected pixels of an intermediate image which is formed by interpolating pixels of said input image using edge-directed interpolation, said intermediate image comprised of pixels at integer coordinates of an intermediate coordinate system;
a sampling-grid generator for determining a corresponding pixel coordinate in said intermediate coordinate system for each pixel of the output image,
an interpolation block for interpolating at least two of said selected pixels of said intermediate image, using said corresponding pixel coordinate to form selected pixels of said output image.

19. The device of claim 18, further comprising an edge-orientation selector interconnected to a Hessian calculator and a diagonal analysis block, wherein said edge-orientation selector receives input from said diagonal analysis block and said Hessian calculator and provides orientation information for said edge-interpolation block.

20. The device of claim 19, further comprising a color-space-conversion block for converting said pixels of said input image provided in RGB format to YUV format.

21. The device of claim 18, wherein said an interpolation block comprises a triangular interpolation block.

22. A method of scaling an input image to form a scaled output image, comprising:
receiving an input image;
generating pixels of an intermediate image from said input image, using edge-directed interpolation;
forming said scaled output image by interpolating said pixels of said intermediate image.

23. The method of claim 22, wherein said output image comprises pixels in said intermediate image and interpolated output pixels formed by interpolating said pixels of said intermediate image.

24. The method of claim 23, wherein said interpolated output pixels are formed using one of triangular interpolation and bilinear interpolation.
